(19) United States
(12) Patent Application Publication
(10) Pub. No.: US 2025/0247031 A1
(43) Pub. Date: Jul. 31, 2025

(54) METHOD AND SYSTEM AND COMPUTER PROGRAM PRODUCT OF ACHIEVING OVERMODULATION OF REFERENCE VOLTAGE

(71) Applicant: Volvo Truck Corporation, GÖTEBORG (SE)

(72) Inventor: Chandrasekhar NAGARAJ, Göteborg (SE)

(21) Appl. No.: 18/855,888

(22) PCT Filed: Jun. 1, 2022
(86) PCT No.: PCT/IB2022/055138

§ 371 Date: Oct. 10, 2024

(51) Int. Cl. H02P 21/14

(52) U.S. Cl. CPC H02P 21/14

(57) ABSTRACT

A method and a system and a computer program product are provided to achieve overmodulation of reference voltage. A D axis and Q axis (DQ) input voltage reference is obtained. The DQ input voltage reference is converted to a three-phase voltage reference. A scaled three-phase voltage reference is generated by applying a desired scaling gain to the three-phase voltage reference. A modulating signal(s) is generated based on the scaled three-phase voltage reference. Duty cycles are calculated based on the modulating signal(s). A gate driver signal(s) is generated based on the duty cycles.

### TECHNICAL FIELD

The present disclosure relates to a method and a system and a computer program product of achieving overmodulation of reference voltage.

### BACKGROUND

Space Vector Pulse Width Modulation (SVPWM) is an algorithm for the control of Pulse Width Modulation (PWM). SVPWM is used to create Alternating Current (AC) waveforms from a Direct Alternating Current (DC) supply, for instance, for electric motors. In SVPWM overmodulation technique is used to increase the available AC voltage to electric machine with the same level of DC link voltage. A higher available AC voltage drastically improves efficiency of electric machine. However, overmodulation technique is very time consuming and extremely complex.

### SUMMARY

According to some embodiments of inventive concepts, a method of achieving overmodulation of reference voltage is provided. The method may include obtaining a D axis and Q axis (DQ) input voltage reference, converting the DQ input voltage reference to a three-phase voltage reference, generating a scaled three-phase voltage reference by applying a desired scaling gain to the three-phase voltage reference, generating a modulating signal(s) based on the scaled three-phase voltage reference, calculating duty cycles based on the modulating signal(s), and generating a gate driver signal(s) based on the duty cycles.

According to some embodiments of inventive concepts, a system of achieving overmodulation of reference voltage is provided. The system may include a processor and a sensor. The sensor may be electrically coupled with the processor. The processor may be configured to perform obtaining a D axis and Q axis (DQ) input voltage reference via the sensor, converting the DQ input voltage reference to a three-phase voltage reference, generating a scaled three-phase voltage reference by applying a desired scaling gain to the three-phase voltage reference, generating a modulating signal(s) based on the scaled three-phase voltage reference, calculating duty cycles based on the modulating signal(s), and generating a gate driver signal(s) based on the duty cycles.

According to some embodiments of inventive concepts, a computer program product of achieving overmodulation of reference voltage is provided. The computer program product may include a non-transitory computer readable medium and a program code. The program code may be stored in the non-transitory computer readable medium that when executed by a system causes the system to perform obtaining a D axis and Q axis (DQ) input voltage reference, converting the DQ input voltage reference to a three-phase voltage reference, generating a scaled three-phase voltage reference by applying a desired scaling gain to the three-phase voltage reference, generating a modulating signal(s) based on the scaled three-phase voltage reference, calculating duty cycles based on the modulating signal(s), and generating a gate driver signal(s) based on the duty cycles.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a flowchart diagram illustrating operations of a method of achieving overmodulation of reference voltage according to some embodiments of inventive concepts;

FIG. 2 is a flowchart diagram illustrating operations of a method of achieving overmodulation of reference voltage according to some embodiments of inventive concepts;

FIG. 3 is a flowchart diagram illustrating operations of a method of achieving overmodulation of reference voltage according to some embodiments of inventive concepts;

FIG. 4 is a flowchart diagram illustrating operations of a method of achieving overmodulation of reference voltage according to some embodiments of inventive concepts;

FIG. 5 is a flowchart diagram illustrating operations of a method of achieving overmodulation of reference voltage according to some embodiments of inventive concepts;

FIG. 6 is a flowchart diagram illustrating operations of a method of achieving overmodulation of reference voltage according to some embodiments of inventive concepts;

FIG. 7 is a flowchart diagram illustrating operations of a method of achieving overmodulation of reference voltage according to some embodiments of inventive concepts;

FIG. 8 is a flowchart diagram illustrating operations of a method of achieving overmodulation of reference voltage according to some embodiments of inventive concepts;

FIG. 9 is a schematic diagram illustrating components of a system of achieving overmodulation of reference voltage according to some embodiments of inventive concepts; and

FIG. 10 is a schematic diagram illustrating a computer program product of achieving overmodulation of reference voltage according to some embodiments of inventive concepts.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

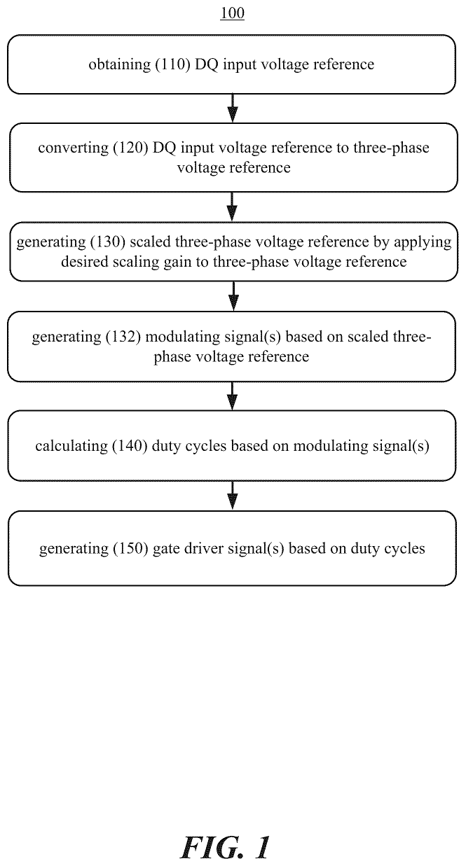

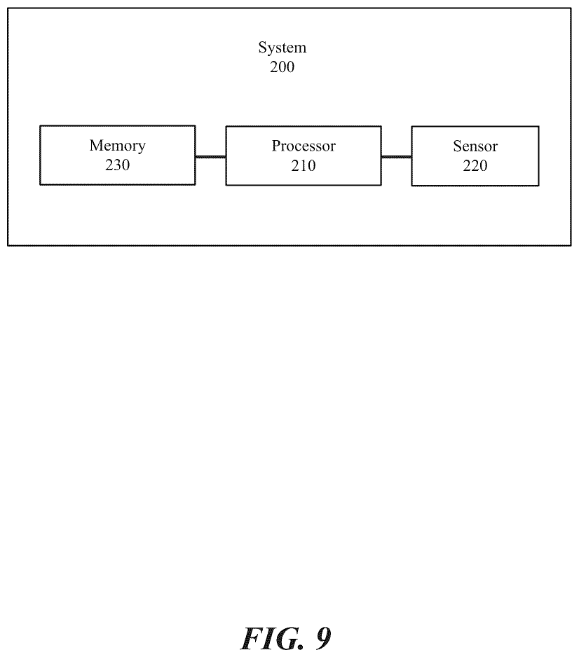

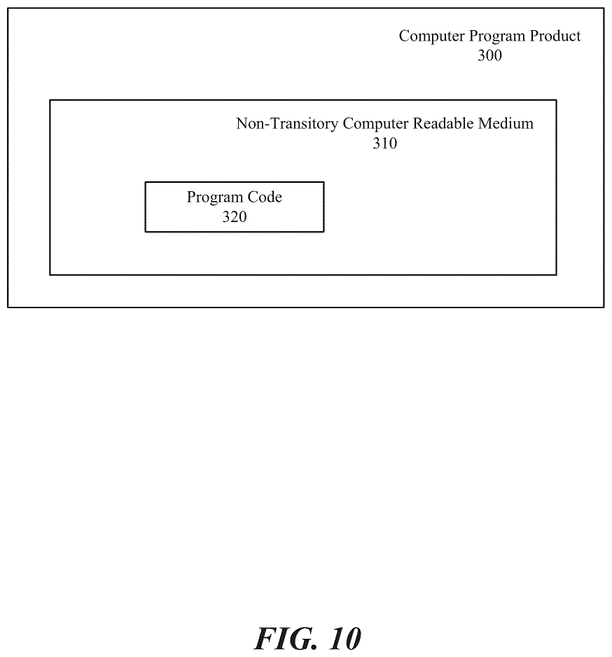

FIGS. 1-8 are flowchart diagrams illustrating operations of a method of achieving overmodulation of reference voltage according to some embodiments of inventive concepts. FIG. 9 is a schematic diagram illustrating components of a system of achieving overmodulation of reference voltage according to some embodiments of inventive concepts. FIG. 10 is a schematic diagram illustrating components of a computer program product of achieving overmodulation of reference voltage according to some embodiments of inventive concepts. Like numbers in the figures refer to like operations and like components.

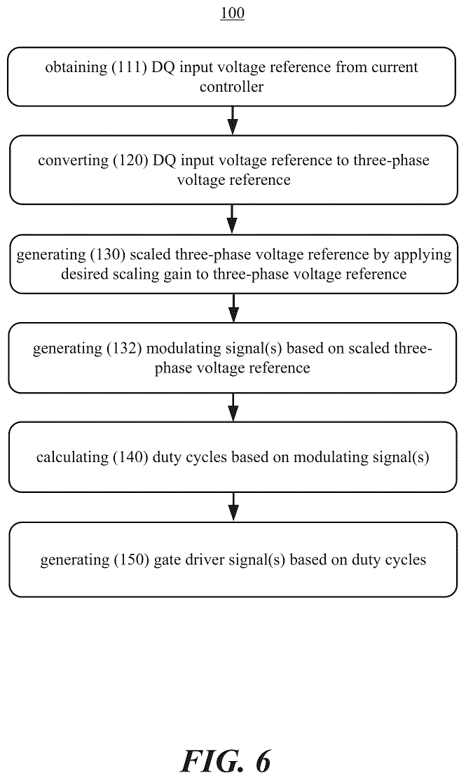

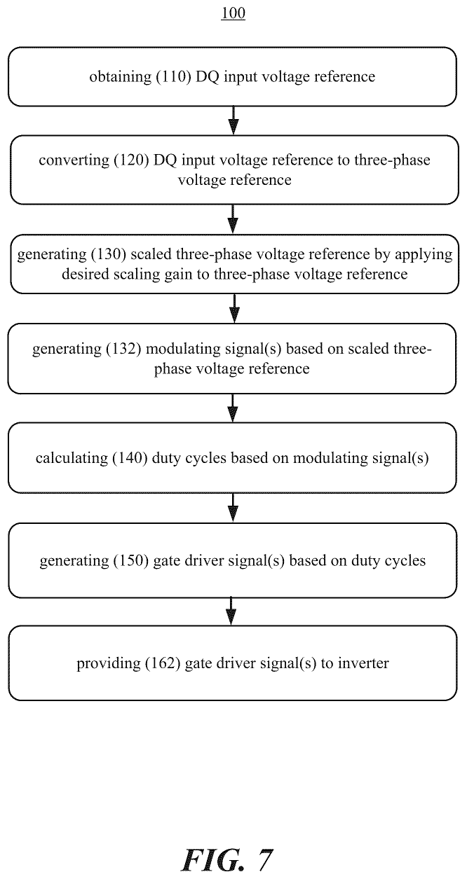

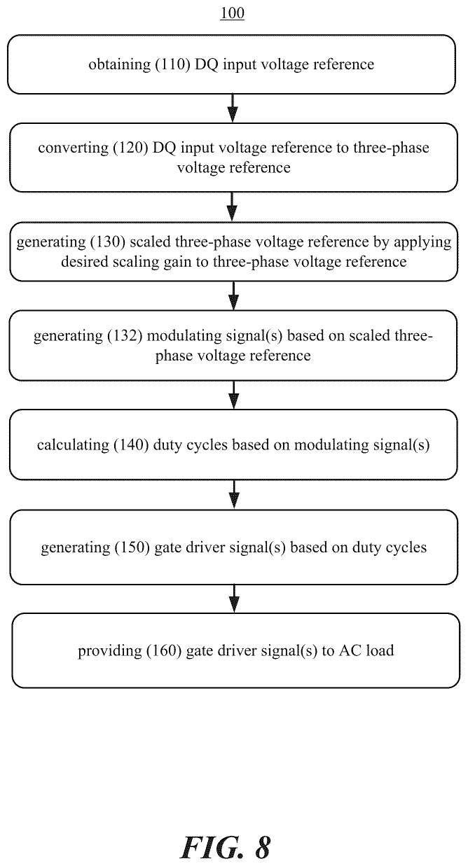

Referring now to FIG. 1, a method of achieving overmodulation of reference voltage is provided. In the method, a D axis and Q axis (DQ) input voltage reference may be obtained (block 110). For example, the DQ input voltage reference may be obtained from a current controller (block 111), as shown in FIG. 6. Then, the DQ input voltage reference may be converted to a three-phase voltage reference (block 120). Thereafter, a scaled three-phase voltage reference may be generated by applying a desired scaling gain to the three-phase voltage reference (block 130). Once the scaled three-phase voltage reference is generated, a modulating signal(s) may be generated based on the scaled three-phase voltage reference (block 132). In an aspect, the scaled three-phase voltage reference may be added with a suitable common mode component and then may be limited appropriately due to hardware limitations to obtain the modulating signal(s). Thus, duty cycles may be accordingly calculated based on the modulating signal(s) (block 140). Finally, a gate driver signal(s) may be generated based on the duty cycles (block 150). The gate driver signal(s) may be, for instance, provided to an Alternating Current (AC) load (block 160), as shown in FIG. 8. The AC load may be a three phase AC load with switched voltages. Alternatively, the gate driver signal(s) may be provided the gate driver signal(s) to an inverter (block 162), as shown in FIG. 7. On the other hand, the gate driver signal(s) may be provided to the inverter and subsequently to the switched voltages on the three phase AC load. The method may achieve overmodulation all the way up to six steps via the single desired scaling gain applied to the three-phase voltage reference, thereby significantly decreasing execution time, because two separate algorithms are not required and sinus and cosinus calculations can be avoided.

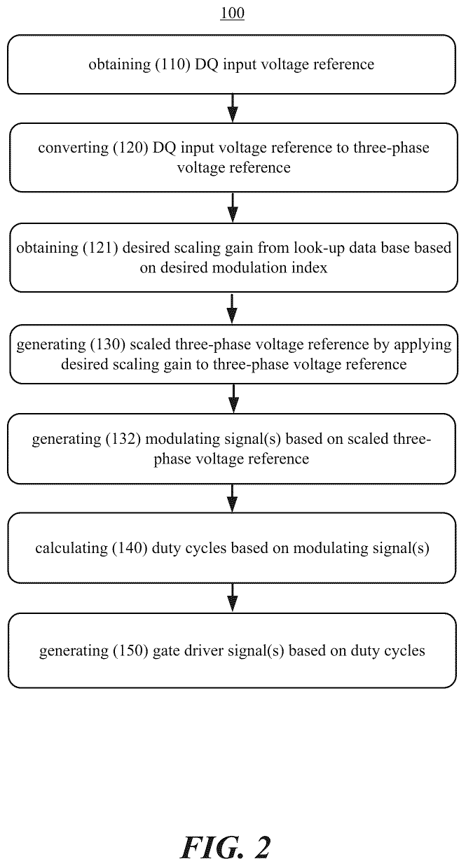

As can be seen in FIG. 2, according to some embodiments, the desired scaling gain may be obtained from a look-up data base based on a desired modulation index (block 121), and then may be applied to the three-phase voltage reference, in order to generate the scaled three-phase voltage reference.

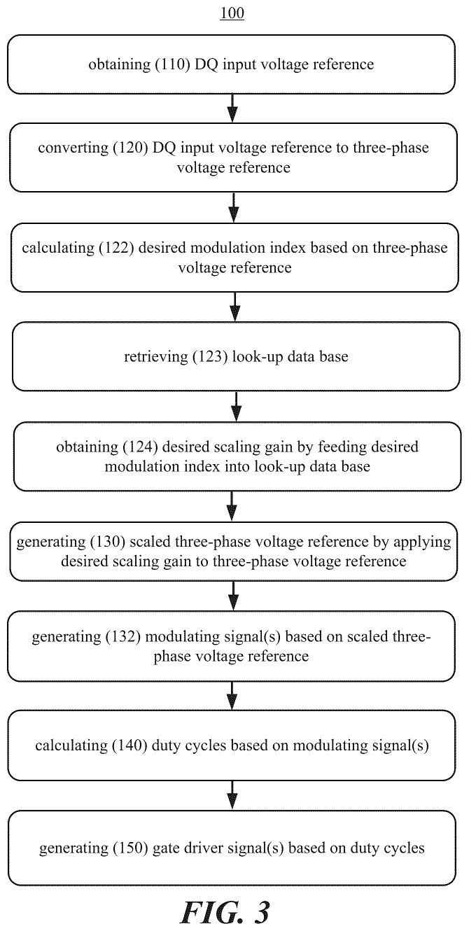

According to some embodiments, reference now is made to FIG. 3. After the DQ input voltage reference is converted to the three-phase voltage reference, the desired modulation index may be calculated based on the three-phase voltage reference (block 122). The look-up data base may be retrieved before or after the desired modulation index is calculated (block 123). The desired modulation index may be fed into the look-up data base, once the look-up data base is retrieved, such that the desired scaling gain which corresponds to the desired modulation index may be obtained (block 124).

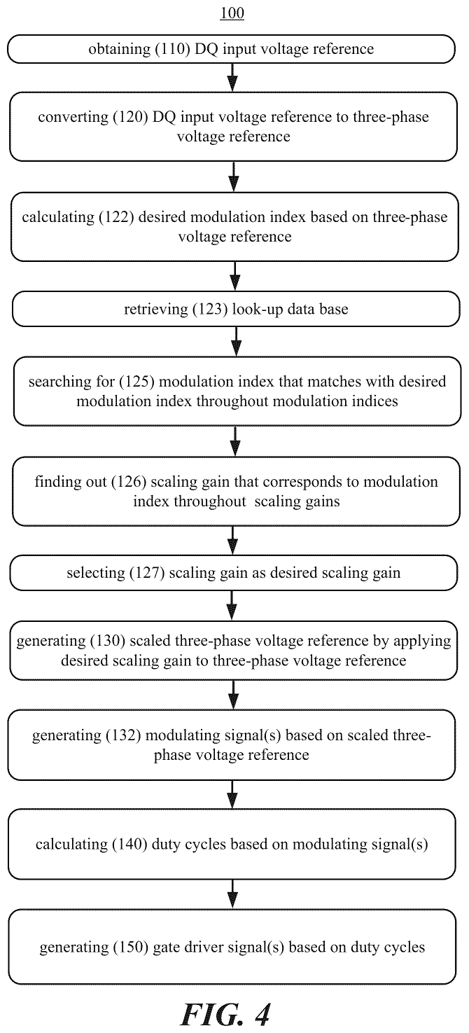

According to some embodiments, as can be seen in FIG. 4, in an example, the look-up data base may comprise a plurality of modulation indices and a plurality of scaling gains. The plurality of scaling gains correspond to the plurality of modulation indices. Furthermore, the desired modulation index may be from the plurality of modulation indices, and the desired scaling gain is from the plurality of scaling gains. Specifically, when the desired modulation index is fed into the look-up data base, a modulation index that matches with the desired modulation index may be searched for throughout the plurality of modulation indices of the look-up data base. Accordingly, a scaling gain that corresponds to the modulation index may be found out throughout the plurality of scaling gains of the look-up data base (block 126). At the time that the scaling gain is found out throughout the plurality of scaling gains, the scaling gain may be selected as the desired scaling gain (block 127), such that the desired scaling gain which corresponds to the desired modulation index may be obtained.

According to some embodiments, in the look-up data base, when the desired modulation index may be less than around 0.995, the desired scaling gain may gradually increase from 1 to around 5. Additionally, according to some embodiments, in the look-up data base, when the desired modulation index may be larger than around 0.995, the desired scaling gain may drastically increase from around 5. The value 0.995 is specific due to hardware limitations, but might be changed for other applications.

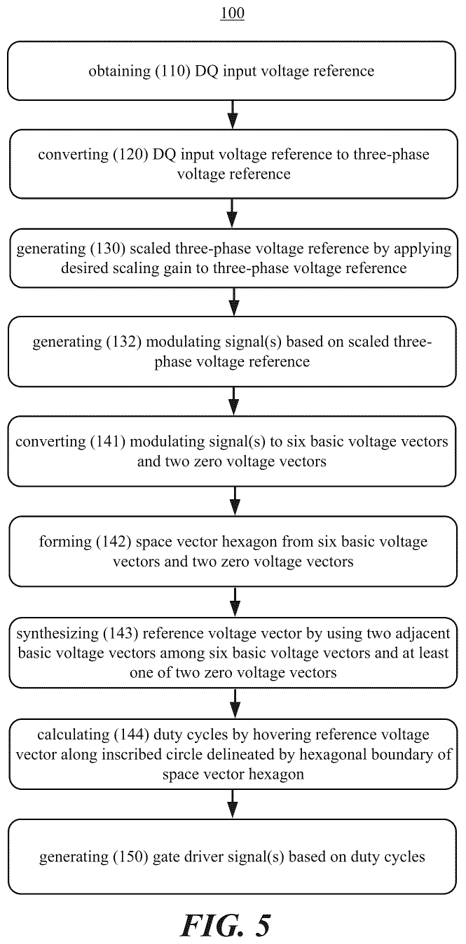

Now reference is made to FIG. 5. Calculating the duty cycles based on the modulating signal(s) may comprise a plurality of steps. First, the modulating signal(s) may be converted to six basic voltage vectors and two zero voltage vectors (block 141). The six basic voltage vectors and the two zero voltage vectors may form a space vector hexagon (block 142). The space vector hexagon may comprise a hexagonal boundary, and the hexagonal boundary may delineate an inscribed circle. Additionally, a reference voltage vector may be synthesized by using two adjacent basic voltage vectors among the six basic voltage vectors and at least one of the two zero voltage vectors (block 143). Therefore, the duty cycles may be calculated by hovering the reference voltage vector along the inscribed circle delineated by the hexagonal boundary of the space vector hexagon (block 144).

FIG. 9 is a schematic diagram illustrating a system 200 which is used to perform the above recited method. Specifically, the system 200 may be used to achieve overmodulation of reference voltage according to some embodiments of inventive concepts.

As illustrated in FIG. 9, according to some embodiments, the system 200 may comprise a processor 210 and a sensor 220. The sensor 220 may be electrically coupled with the processor 210. Specifically, the processor 210 is configured to perform the above recited method. For example, the processor 210 is configured to obtain the DQ input voltage reference from the current controller via the sensor 220. The system 200 may further comprise a memory 230. The memory 230 may be also electrically coupled with the processor 210. In an example, the processor 210 is configured to retrieve the look-up data base from the memory 230.

FIG. 10 is a schematic diagram illustrating a computer program product 300 which is used to perform the above recited method. Specifically, the computer program product 300 may be used to achieve overmodulation of reference voltage according to some embodiments of inventive concepts.

As illustrated in FIG. 10, according to some embodiments, the computer program product may comprise a non-transitory computer readable medium 310 and a program code 320. The program code 320 may be stored in the non-transitory computer readable medium 310 that when executed by the above recited system 200 causes the system 200 to perform the above recited method.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est”, may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of achieving overmodulation of reference voltage, the method comprising:
obtaining a D axis and Q axis (DQ) input voltage reference;
converting the DQ input voltage reference to a three-phase voltage reference;
generating a scaled three-phase voltage reference by applying a desired scaling gain to the three-phase voltage reference;
generating a modulating signal(s) based on the scaled three-phase voltage reference;
calculating duty cycles based on the modulating signal(s); and
generating a gate driver signal(s) based on the duty cycles.

2. The method of claim 1, further comprising:
obtaining the desired scaling gain from a look-up data base based on a desired modulation index.

3. The method of claim 2, further comprising:
calculating the desired modulation index based on the three-phase voltage reference;
retrieving the look-up data base; and
obtaining the desired scaling gain by feeding the desired modulation index into the look-up data base, wherein the desired scaling gain corresponds to the desired modulation index.

4. The method of claim 3, wherein the look-up data base comprises a plurality of modulation indices and a plurality of scaling gains, the plurality of scaling gains correspond to the plurality of modulation indices, the desired modulation index is from the plurality of modulation indices, and the desired scaling gain is from the plurality of scaling gains.

5. The method of claim 4, further comprising:
searching for a modulation index that matches with the desired modulation index throughout the plurality of modulation indices;
finding out a scaling gain that corresponds to the modulation index throughout the plurality of scaling gains; and
selecting the scaling gain as the desired scaling gain.

6. The method of claim 2, wherein in the look-up data base the desired scaling gain gradually increases from 1 to around 5 when the desired modulation index is less than around 0.995.

7. The method of claim 2, wherein in the look-up data base the desired scaling gain drastically increases from around 5 when the desired modulation index is larger than around 0.995.

8. The method of claim 1, wherein calculating the duty cycles based on the modulating signal(s) comprises:
converting the modulating signal(s) to six basic voltage vectors and two zero voltage vectors;
forming a space vector hexagon from the six basic voltage vectors and the two zero voltage vectors, wherein the space vector hexagon comprises a hexagonal boundary, and the hexagonal boundary delineates an inscribed circle;
synthesizing a reference voltage vector by using two adjacent basic voltage vectors among the six basic voltage vectors and at least one of the two zero voltage vectors; and
calculating the duty cycles by hovering the reference voltage vector along the inscribed circle.

9. The method of claim 1, further comprising:
obtaining the DQ input voltage reference from a current controller.

10. The method of claim 1, further comprising:
providing the gate driver signal(s) to an inverter.

11. The method of claim 1, further comprising:
providing the gate driver signal(s) to an Alternating Current (AC) load.

12. A system of achieving overmodulation of reference voltage, the system comprising:
a processor; and
a sensor electrically coupled with the processor,
wherein the processor is configured to perform operations comprising:
obtaining a D axis and Q axis (DQ) input voltage reference via the sensor;
converting the DQ input voltage reference to a three-phase voltage reference;
generating a scaled three-phase voltage reference by applying a desired scaling gain to the three-phase voltage reference;
generating a modulating signal(s) based on the scaled three-phase voltage reference;
calculating duty cycles based on the modulating signal(s); and
generating a gate driver signal(s) based on the duty cycles.

13. The system of claim 12, wherein the operations further comprise:
obtaining the desired scaling gain from a look-up data base based on a desired modulation index.

14. The system of claim 13, further comprising:
a memory electrically coupled with the processor,
wherein the operations further comprise:
calculating the desired modulation index based on the three-phase voltage reference;
retrieving the look-up data base from the memory; and
obtaining the desired scaling gain by feeding the desired modulation index into the look-up data base, wherein the desired scaling gain corresponds to the desired modulation index.

15. The system of claim 14, wherein the look-up data base comprises a plurality of modulation indices and a plurality of scaling gains, the plurality of scaling gains correspond to the plurality of modulation indices, the desired modulation index is from the plurality of modulation indices, and the desired scaling gain is from the plurality of scaling gains.

16. The system of claim 15, wherein the operations further comprise:
searching for a modulation index that matches with the desired modulation index throughout the plurality of modulation indices;
finding out a scaling gain that corresponds to the modulation index throughout the plurality of scaling gains; and
selecting the scaling gain as the desired scaling gain.

17. (canceled)

18. (canceled)

19. The system of claim 12, wherein the operations of calculating the duty cycles based on the modulating signal(s) comprise:
converting the modulating signal(s) to six basic voltage vectors and two zero voltage vectors;
forming a space vector hexagon from the six basic voltage vectors and the two zero voltage vectors, wherein the space vector hexagon comprises a hexagonal boundary, and the hexagonal boundary delineates an inscribed circle;
synthesizing a reference voltage vector by using two adjacent basic voltage vectors among the six basic voltage vectors and at least one of the two zero voltage vectors; and
calculating the duty cycles by hovering the reference voltage vector along the inscribed circle.

20. The system of claim 12, wherein the operations further comprise:
obtaining the DQ input voltage reference from a current controller via the sensor.

21. The system of claim 12, wherein the operations further comprise:
providing the gate driver signal(s) to an inverter.

22. (canceled)

23. A computer program product of achieving overmodulation of reference voltage, the computer program product comprising:
a non-transitory computer readable medium; and
a program code stored in the non-transitory computer readable medium that when executed by a system causes the system to perform operations comprising:
obtaining a D axis and Q axis (DQ) input voltage reference;
converting the DQ input voltage reference to a three-phase voltage reference;
generating a scaled three-phase voltage reference by applying a desired scaling gain to the three-phase voltage reference;
generating a modulating signal(s) based on the scaled three-phase voltage reference;
calculating duty cycles based on the modulating signal(s); and
generating a gate driver signal(s) based on the duty cycles.

24.-33. (canceled)
